(19) United States
(12) Patent Application Publication
(10) Pub. No.: US 2014/0274648 A1
(43) Pub. Date: Sep. 18, 2014

(54) MULTILUMEN CONNECTOR TO MULTIPLE INDIVIDUAL TUBING

(71) Applicant: FENWAL, INC., Lake Zurich, IL (US)

(72) Inventors: Gregory G. Pieper, Waukegan, IL (US); Salvatore Manzella, JR., Barrington, IL (US); Terry Chung, Kildeer, IL (US); Brian Case, Lake Villa, IL (US); Richard West, Lake Villa, IL (US)

(73) Assignee: Fenwal, Inc., Lake Zurich, IL (US)

(21) Appl. No.: 13/835,255

(22) Filed: Mar. 15, 2013

(51) Int. Cl. B04B 5/04

(52) U.S. Cl. CPC B04B 5/0442
USPC 494/18; 29/890.09

(57) ABSTRACT

An umbilicus for use in an umbilicus-drive fluid processing centrifuge system is disclosed, together with a method of making it and a fluid flow circuit including such umbilicus. The umbilicus includes an elongated umbilicus body, a first end fitting defining an interior cavity, an adapter received within the interior cavity and having at least one port extension extending into a fluid transmitting lumen of the umbilicus body, the adapter and end fitting including interfering surfaces to enhance torque resistance therebetween.

### FIELD OF THE DISCLOSURE

The present subject matter relates to an umbilicus for use in a fluid processing system and more particularly to connection of the umbilicus to individual flow tubing.

### DESCRIPTION OF RELATED ART

Whole blood is routinely separated into its various components, such as red blood cells, platelets, and plasma. In continuous blood processing systems, whole blood is drawn from a donor, the particular blood component or constituent is removed and collected, and the remaining blood constituents are returned to the donor. By thus removing only particular constituents, less time is needed for the donor's body to return to normal, and donations can be made at more frequent intervals than when whole blood is collected. This increases the overall supply of blood constituents, such as plasma and platelets, made available for health care.

Whole blood is typically separated into its constituents through centrifugation. This requires that the whole blood be passed through a centrifuge after it is withdrawn from, and before it is returned to, the donor. To avoid contamination, the blood is usually contained within a sealed, sterile fluid flow system during the entire centrifugation process. Typical blood processing systems thus include a permanent, reusable centrifuge assembly or “hardware” that spins and pumps the blood, and a disposable, sealed and sterile fluid processing or fluid circuit assembly that actually makes contact with the donor's blood. The centrifuge assembly engages and spins a portion of the fluid processing assembly (often called the centrifuge or separation chamber) during a collection procedure. The blood, however, makes actual contact only with the disposable fluid processing assembly, which is used only once and then discarded.

To avoid the need for rotating seals, and to preserve the sterile and sealed integrity of the fluid processing assembly, continuous blood processing systems often utilize centrifuges that operate on the “one-omega, two-omega” operating principle. This principle is disclosed in detail in U.S. Pat. No. 4,120,449 to Brown et al., which is hereby incorporated by reference, and enables centrifuges to spin a sealed, closed system without the need for rotating seals. Blood processing systems that make use of the principle typically include a fluid processing assembly that includes a plastic bag or molded chamber that is spun in the centrifuge and that is connected to the blood donor and to a stationary portion of the centrifuge assembly through an elongated member that may be made up of one or more plastic tubes. The elongated member is commonly referred to as an “umbilicus” and is typically arranged in a question mark (or upside-down question mark) configuration with both of its end portions coaxially aligned with the axis of rotation of the centrifuge. The centrifuge chamber is rotated at “two-omega” RPM and the umbilicus is orbited around the centrifuge chamber at “one-omega” RPM. In other words, one end of the umbilicus is stationary, the other end rotates at a two-omega speed with the centrifuge chamber to which it is attached, and the intermediate portion or midsection of the umbilicus orbits about the chamber at a one-omega speed. The effect is that the end of the umbilicus, which is opposite the bag or chamber and is connected to the donor via plastic tubing, does not twist up as the bag is spun. The sealed, sterile integrity of the fluid processing assembly is thus maintained without the need for rotating seals.

U.S. Pat. No. 5,996,634 to Dennehey et al., which is hereby incorporated herein by reference, discloses one such blood processing apparatus based on the “one-omega, two-omega” operating principle. In this apparatus, a disposable fluid processing assembly having an umbilicus and a processing chamber is mountable within a centrifuge assembly. One “fixed” end of the umbilicus is held rotationally stationary substantially over the axis of centrifugation. The other “free” end of the umbilicus joins the processing chamber and is free to rotate with the processing chamber around the axis of centrifugation. The mid-portion of the umbilicus is supported by a wing plate that orbits the mid-portion of the umbilicus around the axis of centrifugation at the one-omega speed. On account of having one “fixed” end and one “free” end, the umbilicus will “twist” about its own central axis as its mid-portion orbits around the processing chamber. The action of the umbilicus naturally “untwisting” itself will cause its “free” end (and, hence, the associated processing chamber) to spin at the average prescribed two-omega speed. This arrangement eliminates the need for complex gearing or belting arrangements to create a one-omega, two-omega drive relationship that was common in prior art devices. The umbilicus itself drives the processing chamber at a two-omega speed.

A typical umbilicus comprises a unitarily formed (generally by an extrusion process) main body defining a plurality of fluid-transmitting lumen. The body is formed of a material specially selected to perform the several required functions of the umbilicus, including being flexible enough to assume the proper orientation with regard to the centrifuge assembly, rigid enough to serve as a drive mechanism for rotating the processing chamber, and having a torsional stiffness leading to the aforementioned “untwisting” at the proper two-omega speed during fluid processing. A known material used in forming the umbilicus is the thermoplastic polyester elastomeric material sold by E.I. DuPont de Nemours & Company under the trademark Hytrel®. The Hytrel® material may also be used to form enlarged end blocks that are over-molded onto the ends of the umbilicus for being clamped into different portions of the centrifuge assembly, with one (the “zero omega end block”) being held in place with respect to the centrifuge assembly and the other (the “two omega end block”) allowed to rotate freely, as described above. Polyvinyl choloride (“PVC”) tubing connecting the umbilicus to the remainder of fluid circuit assembly is bonded to the end blocks.

While such a known umbilicus has proven suitable, it can be relatively expensive to manufacture, and the need remains for a relatively low-cost improved umbilicus.

### SUMMARY

There are several aspects of the present subject matter which may be embodied separately or together in the devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, an umbilicus for use in an umbilicus-driven fluid processing system comprises an elongated umbilicus body including first and second ends, and defines at least one fluid-transmitting lumen extending between the first and second ends, a first end fitting defining an interior cavity and including an elongated bore communicating with the cavity, the first end of the umbilicus body extending into the bore and being fixedly attached to the fitting. The interior cavity of the first end fitting includes a flared portion, and an adapter including a tapered portion is received within the interior cavity of the first end fitting with the tapered portion received within the flared portion and has at least one port extension extending into the fluid transmitting lumen of the umbilicus body. The adapter includes a lumen extending through the port extension and communicating between the at least one umbilicus lumen and a tubing port defined in the adapter, and the adapter and end fitting including interfering surfaces to enhance torque resistance therebetween.

In accordance with another aspect, a method is provided for manufacturing an umbilicus for use in an umbilicus-driven fluid processing system. The method includes providing an elongated umbilicus body having first and second ends and defining at least one fluid-transmitting lumen extending therebetween, providing a first end fitting defining an interior cavity having a flared portion and a bore communicating with the inner cavity, inserting the first end of the umbilicus body within the bore and fixedly attaching the umbilicus to the first end fitting, and inserting an adapter including a tapered portion into the cavity with the tapered portion received within the flared portion of the interior cavity. The adapter has at least one port extension extending into the fluid transmitting lumen of the umbilicus body, and the adapter includes a lumen extending through the port extension and communicating between the at least one umbilicus lumen and a tubing port defined in the adapter. The adapter and end fitting include interfering surfaces to enhance torque resistance therebetween, and the method further includes connecting a separate tube to the tubing port of the adapter.

In accordance with yet another aspect, a pre-assembled disposable centrifugal processing fluid circuit is provided, including a centrifugal processing chamber for rotating within the centrifuge and an umbilicus communicating at a first end with the centrifuge chamber and being configured at a second end for securing to a non-rotating portion of a centrifuge. The umbilicus body includes at least one fluid-transmitting lumen extending between the first and second ends, a first end fitting defining an interior cavity and including an elongated bore communicating with the cavity, the first end of the umbilicus body extending into the bore and being fixedly attached to the fitting. The interior cavity of the first end fitting includes a flared portion, and an adapter including a tapered portion is received within the interior cavity of the first end fitting with the tapered portion received within the flared portion and has at least one port extension extending into the fluid transmitting lumen of the umbilicus body. The adapter includes a lumen extending through the port extension and communicating between the at least one umbilicus lumen and a tubing port defined in the adapter. The adapter and end fitting including interfering surfaces to enhance torque resistance therebetween.

### BRIEF DESCRIPTION OF THE DRAWINGS

FIG. 1 is a perspective view of an exemplary durable fluid processing system that may be used in combination with umbilici according to the present disclosure;

FIG. 2 is a perspective view of a disposable fluid processing assembly usable in association with the durable fluid processing system of FIG. 1;

FIG. 3 is a side elevational view of the disposable fluid processing assembly of FIG. 2 mounted on the durable fluid processing system of FIG. 1, which is partially broken away;

FIG. 4 is a side detail view of a centrifuge included in the durable fluid processing system of FIG. 1, showing the centrifuge in combination with an umbilicus of the disposable fluid processing assembly;

FIG. 5 is a side view of an umbilicus according to one aspect of the present disclosure.

FIG. 6 is a perspective view of a first end of the umbilicus of FIG. 5 according to one aspect of the present disclosure, with portions of the first end fitting in line view only for better viewing of the internal features and arrangement of parts of the present subject matter.

FIG. 7 is a cross-sectional perspective view of the first end of the umbilicus of FIG. 5.

### DESCRIPTION OF THE ILLUSTRATED EMBODIMENTS

The embodiments disclosed herein are for the purpose of providing the required description of the present subject matter. They are only exemplary, and may be embodied in various forms and in various combinations. Therefore, specific details disclosed herein are not to be interpreted as limiting the subject matter as defined in the accompanying claims.

FIG. 1 shows an exemplary durable centrifugal fluid processing device or system 10 that may be used in combination with a fluid processing circuit having an umbilicus according to the present disclosure, although it should be understood that other centrifugal fluid processing systems may be employed without departing from the scope of the present disclosure. The system 10 represented in FIG. 1 is currently marketed as the AMICUS® separator by Fenwal, Inc. of Lake Zurich, Ill. The system 10 can be used for processing various fluids, but is particularly well suited for processing whole blood, blood components, or other suspensions of biological cellular materials. The system 10 includes a centrifuge assembly 12 for separating a fluid into its constituent parts. A more detailed description of the centrifuge assembly 12 and the other elements of the system 10 can be found in U.S. Pat. No. 5,996,634, which is incorporated by reference herein.

The durable fluid processing system 10 is used in combination with a disposable processing set or fluid circuit 14, an example of which is shown in FIG. 2. FIG. 3 shows the disposable set 14 mounted on the durable system 10. The disposable set 14 is a preferably single use, disposable item loaded on the system 10 at the time of use. After a fluid processing procedure has been completed, the operator preferably removes the disposable set 14 from the system 10 and discards it.

The disposable set 14 includes a processing chamber 16 (FIG. 2) and associated fluid flow tubing, containers, and other components. In use, the centrifuge assembly 12 rotates the processing chamber 16 to centrifugally separate blood components. Whole blood is conveyed to the processing chamber 16 from a donor or from another source of blood (such as a bag of collected blood), and separated blood components are conveyed from the processing chamber 16, through a plurality of flexible tubes that form part of a fluid circuit 18. The fluid circuit 18 further includes a plurality of containers 20 that may be supported by elevated hangers located over the centrifuge assembly 12 (see FIG. 3) and that dispense and receive liquids during processing. Fluid flow through the fluid circuit 14 may be controlled in a variety of ways. In the illustrated embodiment, fluid flow is controlled via cassettes 22 with pre-formed fluid passageways, which may be selectively opened and closed pneumatically, hydraulically, or by movable actuators. The number of cassettes may vary, but in the illustrated embodiment, there are three cassettes 22, which operate in association with valve and pump stations on the centrifuge assembly 12 to direct liquid flow among multiple liquid sources and destinations during a blood processing procedure. Tubes connected to the processing chamber 16 lead to a flexible umbilicus 24, with additional tubes at the other end of the umbilicus 24 fluidly connecting the processing chamber 16 (via the umbilicus 24) to the remainder of the disposable set 14, including the containers 20 and the cassettes 22. The umbilicus 24 is shown separately from the disposable set in FIG. 5, while various components and portions thereof are shown in greater detail in FIGS. 6-7 and will be described in greater detail herein. Advantageously, the disposable set 14 is a pre-assembled, pre-sterilized closed system, assuring an operator that it is a sterile unit.

As illustrated, the centrifuge assembly 12 includes a wheeled cabinet 26 that can be easily rolled from place to place. A user-actuable processing controller 30 is provided which enables the operator to control various aspects of the blood processing procedure. A centrifuge rotor assembly 32 is provided behind a fold open door 34 that can be pulled open at the front of the cabinet 26 (FIG. 3). A plurality of valve and pump stations 36 (FIG. 1) are provided on the top face of the cabinet for receiving and controlling the various cassettes 22. A plurality of hooks or hangers 38 are provided on the cabinet 26 for suspending the various containers 20.

In use, the fold open door 34 is opened and the processing chamber 16 of the disposable set 14 is mounted in the centrifuge rotor assembly 32 (FIG. 4). The umbilicus 24 is positioned in an inverted question-mark shape, extending from the centrifuge rotor assembly 32 and out through an opening 40 in the upper panel of the cabinet 26 (FIG. 3). The cassettes 22 are snapped into respective ones of the valve and pump stations 36 and the containers 20 are hung from the appropriate hangers 38 (FIG. 3). After appropriate connections are made to the donor using known intravenous techniques, the operator enters appropriate commands on the processing controller 30 to begin the processing procedure.

Looking more closely at the centrifuge rotor assembly 32 (FIGS. 3 and 4), it includes a chamber assembly 42 that is supported for rotation around an axis of centrifugation 44. The centrifuge further includes a centrifuge yoke assembly 46 that includes a yoke base 48, a pair of upstanding yoke arms 50, and a yoke cross member 52 mounted between the arms 50 (FIG. 3). The yoke base 48 is rotatably supported on a stationary platform 54 that carries the rotating mass of the centrifuge rotor assembly 32. The yoke base 48 is also supported for rotation around the axis of centrifugation independently of the chamber assembly 42. An electric drive 56 rotates the yoke assembly 46 relative to the stationary platform 54 around the axis of centrifugation 44. The chamber assembly 42 is free to rotate around the axis of centrifugation 44 at a rotational speed that is different from the rotational speed of the yoke assembly 46.

Referring further to FIG. 4, the chamber assembly 42 defines an annular chamber 58, centered around the axis of centrifugation 44, for receiving the processing chamber 16 of the disposable set 14. The umbilicus 24 extends through the lower center of the chamber assembly 42 in alignment with the axis of centrifugation 44. An anchor portion or end fitting 60 of the umbilicus 24 (referred to herein as the “two-omega end fitting”) is received in a lowermost umbilicus mount 62 located at the lower center of the chamber assembly 42. The two-omega end fitting 60 and the umbilicus mount 62 function to transfer torque between the umbilicus 24 and chamber assembly 42 so that the chamber assembly 42 rotates around the axis of centrifugation in response to twisting of the umbilicus 24 around its axis.

The other end of the umbilicus 24 is defined by another anchor portion or end fitting 64 (referred to herein as the “zero-omega end fitting”) that is removably received in an upper umbilicus mount 66 positioned over the centrifuge chamber assembly 42 substantially in alignment with the axis of centrifugation 44. An over-center clamp 68 at the end of the upper umbilicus mount 66 clamps onto the zero-omega end fitting 64 to hold the adjacent section of the umbilicus 24 rotationally stationary and in collinear alignment with the axis of centrifugation 44.

As further illustrated in FIG. 4, the portion of the umbilicus 24 between the zero-omega end fitting 64 and the two-omega end fitting 60 may be supported by a middle umbilicus mount or bearing support 70 that is carried at the lower end of a support or wing plate 72 extending outwardly and downwardly from the yoke cross member 52. As the electric drive 56 rotates the centrifuge yoke assembly 46 (FIG. 3) around the axis of centrifugation 44, the intermediate support or wing plate 72 and the bearing support 70 pull the midsection of the umbilicus 24 around the axis of centrifugation 44 as well. As the umbilicus 24 orbits around the axis 44, at rotational speed one-omega, a twisting action is imparted to the umbilicus 24 around its own axis. The midsection of the umbilicus 24 is free to rotate around its own axis relative to the wing plate 72 as the yoke assembly 46 is turned, so it will tend to “untwist” against the twisting motion imparted by the rotating yoke assembly 46. As it untwists in this manner, the umbilicus 24 spins the centrifuge chamber assembly 42 around the axis of centrifugation 44 at an average rotational speed of two-omega.

To maintain balance as the yoke assembly 46 turns, an additional support or wing plate 74 extends from the yoke cross member 52 diametrically opposite the wing plate 72. A counterweight 76 sufficient to balance the mass of the bearing support 70 and umbilicus 24 is preferably carried on the lower end of the additional wing plate 74.

To reduce the risk of damage to the umbilicus 24 during fluid processing, an umbilicus bearing assembly 78 may surround it and be received within the bearing support 70, in a manner well known to those skilled in the art. Exemplary umbilicus bearing assemblies are described in U.S. Pat. Nos. 5,989,177 and 8,277,369 to West et al., which are hereby incorporated herein by reference.

FIG. 5 shows the umbilicus 24 isolated from the remainder of the disposable set 14. The umbilicus 24 preferably comprises and consolidates the multiple fluid paths leading to and from the processing chamber 16, although it may also have only a single flow path. In the illustrated blood processing application, it provides a continuous, sterile environment for fluids (such as blood and blood components) to pass. In construction, the umbilicus 24 is flexible enough to function in the relatively small, compact operating space that the centrifuge assembly 12 provides. Still, the umbilicus 24 is durable enough to withstand the significant flexing and torsional stresses imposed by the small, compact spinning environment, where continuous rotation rates of several thousand revolutions per minute may be typically encountered for periods of up to as much as two or three hours.

In the illustrated embodiment, the umbilicus 24 includes an umbilicus body 80 extending between first and second ends 84 and 82, with an intermediate section or midsection 86 located therebetween. FIG. 6 shows the first end of the umbilicus in much greater detail. As shown there, the first end includes the first end fitting 60, which is sometimes referred to as D-block because of its illustrated (but non-exclusive) shape, one end of the umbilicus body 80 and an adapter 86. In accordance with the present subject matter, the end fitting, umbilicus body and adapter are configured to provide a unique structure that allows for the connection of a plurality of individual tubes to the umbilicus with reduced risk of lumen to lumen leakage and increased torsional strength, among other benefits.

The end fitting 60 is preferably of molded plastic construction, and may be made of any suitable material. For example, it may be made of a thermoplastic polyester elastomeric material, such as Hytrel brand material from DuPont, or may be made of polyvinyl chloride (PVC). As see in FIG. 6, where it is shown for purposes of illustration only, the end fitting 60 includes a generally D-shaped base 88, and opposed generally cylindrical extensions 90 and 92. Extension 90 and a base 88 form an interior cavity 94 for receiving adapter 86. As perhaps better seen in FIG. 7, the cavity 92 has an upper generally hollow cylindrical section 96 and a lower flared or tapered portion 98. The flared portion 98 is shown with an increasing cross sectional size or diameter in a direction toward the upper cylindrical section 94. The flared portion 98 continues and extends downwardly to a large interior lumen or bore 100 that extends through the cylindrical extension 92 of the end fitting 60 and is sized to receive the first end 84 of the umbilicus body 80 in close fitting contact.

As seen in FIG. 7, the end 84 of umbilicus body 80 extends through the bore and extends a selected limited distance into the flared portion 98. For the particular centrifuge described earlier, the umbilicus has at least one and preferably a plurality of separate fluid lumen 102 extending therethrough for flowing blood or blood components into and from the centrifuge processing chamber 16. As illustrated, the umbilicus includes five separate fluid flow lumen 102, although the particular number is not critical to the present disclosure.

The end of the umbilicus body is preferably fixedly attached to the end fitting 60. Although that may be achieved in different ways, in the present disclosure the umbilicus is preferably bonded to the cylindrical extension 92. As one example, the umbilicus may be solvent bonded to the bore 100 in the extension 92 using a suitable solvent for the particular materials used in umbilicus and end fitting 60. For the materials disclosed herein, a solvent such as cyclohexane may be used. The large surface area between the bore 100 and the end of the umbilicus body 80 provides a particularly strong attachment between the umbilicus body and the end fitting that has substantial torsional strength to resist the torsional forces experienced by the umbilicus during centrifuge rotation. In accordance with the present disclosure, however, this strength between the umbilicus and end fitting is further enhanced by the configuration and attachment of the adapter 86 to the end fitting 60.

The adapter 86 is configured for insertion into the interior cavity 94 of the end fitting 60. It is also preferably of molded plastic construction and may be of any suitable material. One example of a suitable material is polyvinyl chloride. The adapter 86 has an upper portion 104 and a lower portion 106, each having a shape complementary to the upper and lower portions 96 and 98, respectively, of the cavity 94. As illustrated, the upper portion 104 is generally cylindrical and the lower portion 106 is generally tapered or flared. The adapter includes an axially extending port extension 108 for each lumen of the umbilicus and, as illustrated, has five port extensions. A separate fluid flow lumen 110 extends through each port extension and into a separate tubing port 112 for attachment to a separate individual flow tube such as PVC tubes 114 shown in FIG. 5.

As best seen in FIG. 7, each port extension 108 extends into a respective lumen 102 of umbilicus body 80. The distal ends of the port extensions are preferably tapered for ease of insertion into the umbilicus lumen, but of increasing cross-sectional dimension so as to radially outwardly compress the interior wall of the lumen. As described earlier, the end of the umbilicus extends a selected distance into the flared portion 98 of interior cavity 94 in the base 88. The outward force of the port extensions 108 on the walls of the umbilicus lumen 102 causes the end of the umbilicus within the flared cavity portion to expand or flare outwardly, capturing the end of the umbilicus tightly between the adapter 86 and the wall of the flared portion 98 of interior cavity 94. The tight compressive engagement of the port extensions within the umbilicus lumen provides increased lumen to lumen seal integrity, reducing the occurrence of leakage and also, due to the capture action described above, increases the axial pull strength of the connection between the umbilicus body 80 and fitting 60.

To further enhance torsional strength of the assembly, the adapter 86 and interior cavity 94 preferably have interfering surfaces that resist relative rotational movement between them. While these surfaces may take any suitable shape, preferably the cavity or the adapter has one or more raised axially extending spline and the other has axially extending slots for receiving the spline. As can been seen in FIGS. 6 and 7, in the illustrated embodiment the adapter has several raised axially extending spline 116 spaced apart around the upper portion 104 of the adapter, and the cylindrical portion 96 of internal cavity 94 has complementary axially extending slots 118 to receive the spine when the adapter is inserted into the interior cavity.

With the above described structure, individual tubes such as individual PVC tubes 114 that extend to the centrifuge processing chamber may be readily connected to the umbilicus by insertion and attachment into the tube ports 112 of the adapter 86. More specifically, as noted above, a preferred material for the adapter 86 is PVC, which can be readily solvent bonded to PVC tubing. It will thus be evident that the present subject matter provides a connection assembly with high pull strength, large torsional resistance and ease of assembly for connecting one or more individual tubes to a centrifuge umbilicus, and has particular application and benefit in making connection between multiple individual tubes and a multi-lumen umbilicus.

The foregoing assembly steps may be practiced in a different order and/or additional assembly steps may be practiced and/or additional or different components may be incorporated into the umbilicus 24 during the assembly process without departing from the scope of the present disclosure.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims.

1. An umbilicus for use in an umbilicus-driven fluid processing system, comprising:
an elongated umbilicus body including first and second ends, wherein the umbilicus body defines at least one fluid-transmitting lumen extending between the first and second ends;
a first end fitting defining an interior cavity and including an elongated bore communicating with the cavity;
the first end of the umbilicus body extending into the bore and being fixedly attached to the fitting;
the interior cavity of the first end fitting includes a flared portion;
an adapter including a tapered portion received within the interior cavity of the first end fitting with the tapered portion received within the flared portion of the interior cavity, and having at least one port extension extending into the at least one fluid transmitting lumen of the umbilicus body;
the adapter including a lumen extending through the port extension and communicating between the at least one umbilicus lumen and a tubing port defined in the adapter and configured for attachment to an individual flow tube; and
the adapter and end fitting including interfering surfaces to enhance torque resistance therebetween.

2. The umbilicus of claim 1, wherein the umbilicus body includes a plurality of lumen and the adapter includes a plurality of port extensions, each port extension extending into a respective umbilicus lumen, and the adapter defining a separate lumen extending through each port extension and communicating between the respective umbilicus lumen into which the port extension extends and a separate tubing port defined in the adapter.

3. The umbilicus of claim 2, including a separate flow tube connected to each of the tubing ports.

4. The umbilicus of claim 1 in which the port extension includes a tapered distal end that is sized for compressive insertion into the fluid transmitting lumen of the umbilicus body.

5. The umbilicus of claim 1, wherein the umbilicus body is comprised of a thermoplastic polyester elastomeric material and the first end fitting is comprised of thermoplastic polyester elastomeric material or polyvinyl chloride.

6. The umbilicus of claim 1, wherein the interfering surfaces comprise at least one raised spine member on one of the adapter or end fitting and at least one spline-receiving slot defined on the other.

7. The umbilicus of claim 1, wherein the first end of the umbilicus is bonded to the first end fitting.

8. The umbilicus of claim 7 wherein the umbilicus and first end fitting are solvent bonded.

9. The umbilicus of claim 8 wherein the surface of the umbilicus and surface of the bore are bonded together by solvent bond.

10. A method of manufacturing an umbilicus for use in an umbilicus-driven fluid processing system, comprising:
providing an elongated umbilicus body having first and second ends and defining at least one fluid-transmitting lumen extending therebetween;
providing a first end fitting defining an interior cavity having a flared portion and a bore communicating with the inner cavity;
inserting the first end of the umbilicus body within the bore and fixedly attaching the umbilicus to the first end fitting;
inserting an adapter including a tapered portion into the cavity with the tapered portion received within the flared portion of the interior cavity, the adapter having at least one port extension extending into the fluid transmitting lumen of the umbilicus body, and the adapter including a lumen extending through the port extension and communicating between the at least one umbilicus lumen and a tubing port defined in the adapter, the adapter and end fitting including interfering surfaces to enhance torque resistance therebetween, and connecting an individual tube to the tubing port of the adapter.

11. The method of claim 10 wherein the umbilicus body defines a plurality of lumen and the adapter includes a plurality of port extensions, each port extension extending into a respective umbilicus lumen, and the adapter defining a separate lumen extending through each port extension and communicating between the respective umbilicus lumen into which the port extension extends the method including connecting a separate tube to each separate tubing port defined in the adapter.

12. The method of claim 10, wherein the fixedly attaching includes bonding the umbilicus to the first end fitting.

13. The method of claim 10, wherein the umbilicus body is comprised of a thermoplastic polyester elastomeric material and the first end fitting is comprised of thermoplastic polyester elastomeric material or polyvinyl chloride.

14. The method of claim 9, wherein the interfering surfaces comprise at least one raised spine member on one of the adapter or end fitting and at least one spline-receiving slot defined on the other.

15. The method of claim 9 wherein the first end fitting is polyvinyl chloride and the separate tube is solvent bonded to the tube port of the first end fitting.

16. A pre-assembled disposable centrifugal processing fluid circuit including a centrifugal processing chamber for rotating within the centrifuge and an umbilicus communicating at a first end with the centrifuge chamber and being configured at a second end for securing to a non-rotating portion of a centrifuge, wherein the umbilicus body includes at least one fluid-transmitting lumen extending between the first and second ends;
a first end fitting defining an interior cavity and including an elongated bore communicating with the cavity;
the first end of the umbilicus body extending into the bore and being fixedly attached to the fitting;
the interior cavity of the first end fitting includes a flared portion;
an adapter including a tapered portion received within the interior cavity of the first end fitting with the tapered portion received within the flared portion of the interior cavity, and having at least one port extension extending into the fluid transmitting lumen of the umbilicus body;
the adapter including a lumen extending through the port extension and communicating between the at least one umbilicus lumen and a tubing port defined in the adapter and configured for attachment to an individual flow tube; and
the adapter and end fitting including interfering surfaces to enhance torque resistance therebetween.

17. The fluid circuit of claim 16, wherein the umbilicus body defines a plurality of lumen and the adapter includes a plurality of port extensions, each port extension extending into a respective umbilicus lumen, and the adapter defining a separate lumen extending through each port extension and communicating between the respective umbilicus lumen into which the port extension extends and a separate tubing port defined in the adapter.

18. The fluid circuit of claim 17, including a separate flow tube connected to each of the tube ports.

19. The fluid circuit of claim 17 in which the port extension includes a tapered distal end that is sized for compressive insertion into the fluid transmitting lumen of the umbilicus body.

20. The fluid circuit of claim 17, wherein the interfering surfaces comprise at least one raised spine member on one of the adapter or end fitting and at least one spline-receiving slot defined on the other.
